(19) United States
(12) Patent Application Publication
(10) Pub. No.: US 2023/0104726 A1
(43) Pub. Date: Apr. 6, 2023

(54) ELECTRIC GRILL WITH SMART POWER BOOSTER

(71) Applicant: W.C. Bradley Co., Columbus, GA (US)

(72) Inventors: JAMES D. KRING, Opelika, AL (US); RAMIN KHOSRAVI RAHMANI, Columbus, GA (US); Thomas Kessler, Columbus, GA (US)

(21) Appl. No.: 17/960,444

(22) Filed: Oct. 5, 2022

Related U.S. Application Data
(60) Provisional application No. 63/252,476, filed on Oct. 5, 2021.

(51) Int. Cl. F24C 7/06; H05B 3/68; H05B 3/02

(52) U.S. Cl. CPC F24C 7/067; H05B 3/68; H05B 3/02

(57) ABSTRACT

A cooking grill utilizes at least one resistive heating element below a cooking grate and radiating heat to the cooking grate when a voltage is applied thereto. A first power source provides an alternating current, and a second power source provides a direct current. First and second power sources provide voltage to the at least one resistive heating element individually or simultaneously.

### CROSS-REFERENCE TO RELATED CASES

This application claims the benefit of U.S. provisional patent application Ser. No. 63/252,476, filed on Oct. 5, 2021, and incorporates such provisional application by reference into this disclosure as if fully set out at this point.

### FIELD OF THE INVENTION

This disclosure relates to managing power demands of an electric appliance in general and, more specifically, to power boosting systems and methods for electric grills.

### BACKGROUND OF THE INVENTION

Electric grills commonly rely on alternating current (AC) from grid power provided to a house to energize a resistive heating element such as a Calrod® heating element. As voltage is applied, electrical resistance leads to generation of thermal energy within the heating element. The temperature at the heating element's surface increases, and its outer surface begins to radiate heat. The radiative heat generated by the element provides heat to a cooking surface, which may be an open cooking grate similar to that used in convective gas grills.

However, available power restricts performance. Commonly, an 1800-watt limit is observed when utilizing common AC household outlets. To achieve and maintain a temperature suitable for grilling (e.g., 450-650° F.), the available cooking area of an electric appliance may be smaller than is necessary or desirable for all grilling applications. Furthermore, a lack of energy transfer into the cooking chamber via mass transfer (e.g., via combustion products generated in a gas or charcoal grill) results in a longer initial warmup time for the grill, a longer recovery time, and lower temperatures for cooking inside the cooking chamber.

What is needed is a system and method for addressing the above, and related, issues.

### SUMMARY OF THE INVENTION

The invention of the present disclosure, in one aspect thereof, comprises a cooking grill having a cooking grate, at least one resistive heating element below the cooking grate and radiating heat to the cooking grate when a voltage is applied thereto, a first power source providing an alternating current; and a second power source providing direct current. The first and second power sources provide voltage to the at least one resistive heating element individually or simultaneously.

In some embodiments, the first power source connects to the at least one resistive heating element via a rectifier. The first power source may comprise a connection to a household alternating current. The second power source may comprise a battery. In another embodiment, the second power source comprises a capacitor.

The first and second power sources may provide power to the at least one resistive heating element simultaneously in series with one another. In some cases, the first and second power sources provide power to the at least one resistive heating element simultaneously in parallel with one another. The first power source may connect to the at least one resistive heating element via a solid-state switch. The second power supply may connect to the at least one resistive heating element via a solid-state switch.

In some embodiments, the at least one resistive heating element comprises a first resistive heating element provided voltage by the first power source and a second resistive heating element provided voltage by the second power source.

The invention of the present disclosure, in another aspect thereof, comprises a cooking grill including a cooking chamber having a cooking surface, a resistive heating element below the cooking surface, a connection to a household voltage source selectively powering the resistive heating element, and a rechargeable voltage source selectively powering the resistive heating element. The household voltage source and the rechargeable voltage source may be selected individually or simultaneously to energize the resistive heating element resulting in radiative heat being applied to the cooking surface.

The grill may further comprise a first solid-state switch interposing the connection to the household voltage source and the resistive heating element, and a second solid-state switch interposing the rechargeable voltage source and the resistive heating element.

The rechargeable voltage source may comprise a battery. In another embodiment, the rechargeable voltage source comprises a capacitor. In some embodiments, the connection to the household voltage source recharges the rechargeable voltage source. The grill may further comprise a second rechargeable voltage source selectively powering the resistive heating element in parallel with the first rechargeable voltage source.

The grill may also include at least one temperature probe connected to a controller that selects both the household voltage source and the rechargeable voltage source to power the resistive heating element when the at least one temperature probe detects a temperature below a predetermined threshold.

The invention of the present disclosure, in another aspect thereof, comprises a grill with a cooking chamber having a cooking surface and at least one resistive heating element situated such that radiative heat from the resistive heating element heats the cooking surface. The grill includes a first power connection to a household alternating current, a second power connection to a rechargeable current source. The grill also includes a first solid-state switch connecting the first power connection to the at least one resistive heating element, and a second solid-state switch connecting the second power connection to the at least one resistive heating element. At least one temperature probe may be included. A controller selectively activates the first solid-state switch and the second solid-state switch to power the at least one resistive heating element with either or both of the first power connection and second power connection based on data from the at least one temperature probe.

In some embodiments, the rechargeable current source comprises a battery that is recharged by the first power connection when the first power connection is not powering the at least one resistive heating element. The at least one resistive heating element may comprise a first heating element connected to the first power connection via the first solid-state switch and a second heating element connected to the second power connection via the second solid-state switch.

### BRIEF DESCRIPTION OF THE DRAWINGS

FIG. 1 is a simplified schematic view of an electric grill equipped with AC and DC power supplies and two temperature probes according to aspects of the present disclosure.

FIG. 2 is a simplified schematic view of an electric grill equipped a booster heating element and a high-capacity capacitor according to aspects of the present disclosure.

FIG. 3 is a circuit diagram of a heating element boosted by a battery according to aspects of the present disclosure.

FIG. 4 is a circuit diagram of a heating element boosted by a supercapacitor according to aspects of the present disclosure.

FIG. 5 is a circuit diagram of a heating element boosted by two different DC power sources according to aspects of the present disclosure.

FIG. 6 is a flow chart illustrating a control method for optimization of power sources according to aspects of the present disclosure.

FIG. 7 is a flow chart illustrating a control method that differentiates between grate and chamber temperature according to aspects of the present disclosure.

### DETAILED DESCRIPTION OF THE PREFERRED EMBODIMENTS

Existing limitations bring the need for a system and method, such as those of the present disclosure, that can complement an electric grill heat generation (i.e., cooking) system that currently relies on a 120 VAC source with its 1800 watt limit output (or other limits imposed by voltage, current, and/or power available from a normal household outlet). Various embodiments of the present disclosure provide for an electric grill to have a larger cooking capacity (both in terms of grate surface and chamber volume sizes) without compromise respecting to the cooking grate temperature. Various embodiments of the present disclosure provide enhanced warmup and recovery times compared with prior solutions as well.

Benefits according to the present disclosure may be achieved by multiple mechanisms. For example, in some embodiments, electrical energy is stored in a direct current (DC) source (such as rechargeable batteries, capacitors or super capacitors, etc.). Some embodiments may discharge this energy in a managed rate at a proper time, using various control systems and methodologies. The control systems of the present disclosure may manage variations of energy discharge in addition to when and where it is deployed.

In some embodiments, a DC energy source can be used in parallel to an AC energy source to energize additional resistive heating element(s) to provide heat for an extended cooking surface and address the need for a larger cooking surface with no reduction in the cooking performance of the grill (e.g., in comparison to a smaller electric grill solely powered by an 1800 watt AC source). The DC source can be used alongside the AC source (energizing the main heating element) in a complementary manner to energize an additional heating element. This provides higher power delivery to the same cooking surface and address the need of having shorter warmup and recovery times. A DC energy source can be used in series with the AC energy source as a booster to provide extra power to the same heating element (e.g. via employment of thyristors, MOSFETs, or some other solid-state control mechanism) to achieve the same goal without using a complementary heating element. Also, a combination of these scenarios can be seen practiced for example in a modular electric grill with two or more cooking modules in which each module can be powered either by AC source or by DC source (or simultaneously by both). Such a system also can use more than one DC source.

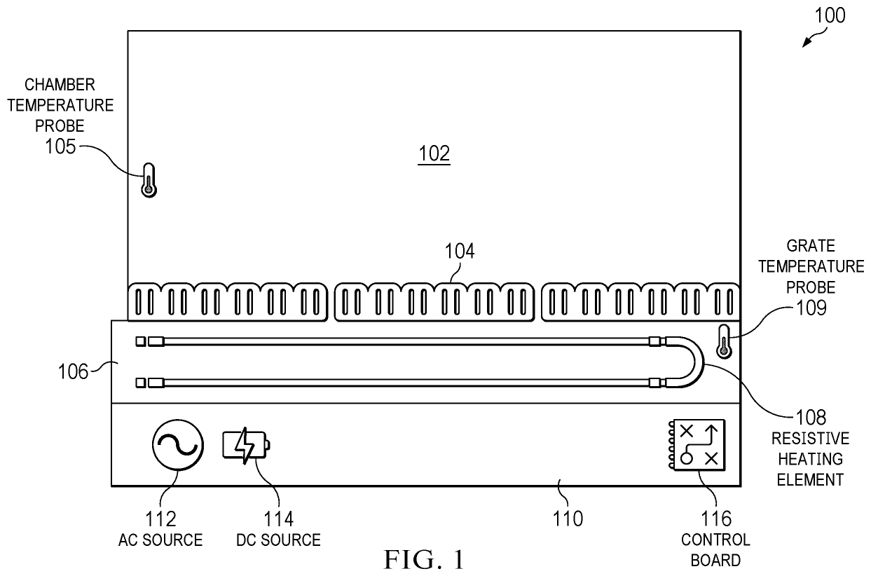

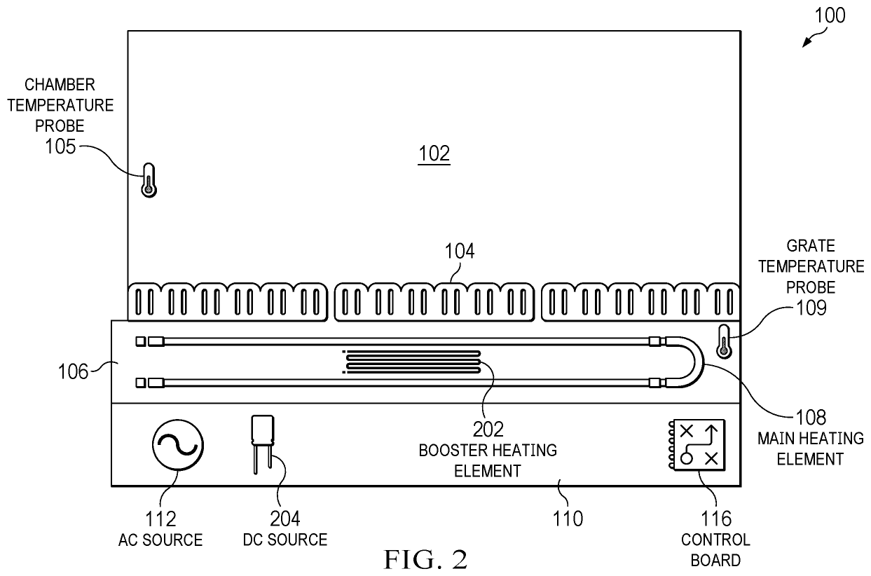

With reference now to specific examples, FIGS. 1-2 show simplified schematic views of an electric grill 100 powered by both an AC source 112 and a DC source 114. The grill 100 may comprise a cooking chamber 102 having a cooking grate 104 situated therein. A temperature probe 105 may be provided for monitoring a temperature inside the cooking chamber 102. Other embodiments may include multiple temperature probes within the cooking chamber 102.

Below the cooking grate 104 is a firebox 106 containing one or more resistive heating elements 108. A second temperature probe 109 may be used to monitor temperatures of the heating element 108, a lower portion of the cooking grate 104, and or other locations in the firebox 106. Some embodiments utilize multiple temperature probes within the firebox 106. The temperature probes 105, 109, and any others utilized with the grill 100, may comprise various temperature sensing technologies as known to the art.

A separate cabinet, space, or spaces (shown as cabinet 110 here) may provide an AC source 112 or a connection to a household outlet. A DC source 114 may also be included in the space or cabinet 110, along with any necessary control board, controller 116, or other device for controlling operation of the grill 100. The controller 116 may be a solid state device such or controller such as a processor, microcontroller, field programmable gate array (FPGA), or other device that may be configured as is known the art, via software, firmware, or otherwise to control grilling operations as described herein.

The DC source 114 can be a battery (114, FIG. 1) or a capacitor or supercapacitor (204, FIG. 2). Where the DC source is a battery, any suitable battery chemistry known to the art may be used. Some embodiments may contain multiple DC sources such that different types of DC sources are available. In one example, one DC source is used to boost the heating of the cooking grate 104 (for example, as it starts from a cold ambient condition) and the other is used to boost heating of the cooking chamber 102 (for example, as it recovers from opening of a lid). Thus, the system 100 may have one or multiple batteries, and/or one or multiple supercapacitors.

The system 100 may have one or multiple main heating elements (e.g., 108). The system may have one or more booster heating elements 202. Each heating element (main 108 or booster 202) may be energized by one or more power source(s) (e.g., 112, 114, 204) with similar or different rates. The system 100 may be comprised with multiple modular cooking subsystems in order to create the equivalent of multi-burner gas grill with higher precision and more distinguishable zones. In some cases, one power supply source 112, 114, 204 may be configured to power the main heating element(s) 108, and another configured to power the booster heating element(s) 202.

Leads, traces, knobs, plugs, connections and other necessary implements as are known in the art are not shown. One of skill in the art will appreciate that there are many possible specific wiring schemes that can implement the functionality and structure disclosed herein. The system 100 may be stationary or may comprise a cabinet or stand with wheels or rollers for moving the system 100 from one location to another. Charging devices and implements needed for the batteries and/or capacitors may be provided as are known in the art. The present disclosure is not meant to be limited to any specific battery chemistry or charging mechanism.

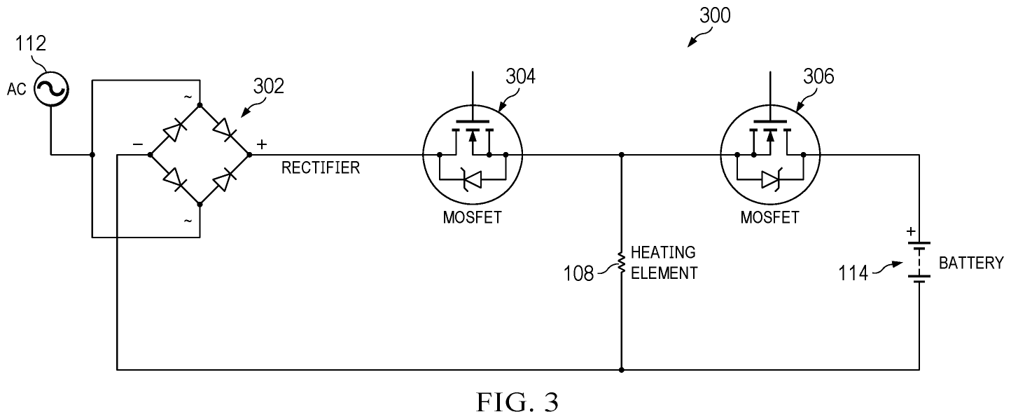

Referring now to FIG. 3, a circuit diagram 300 of a heating element boosted by a battery 114 according to aspects of the present disclosure is shown. The diagram 300 provides additional detail for an implementation of a device such as that shown in FIG. 3. A rectifier 302 may be utilized to convert the AC source 112 to a non-alternating voltage/current source for powering the heating element 108 via a metal oxide semiconductor field effect transistor (MOSFET) 304 or other solid state or other switching device. The battery 114 may be used to boost power to the heating element 108 via MOSFET 306 or other solid state or other switching device. It will be appreciated that the MOSFET 304 allows the rectified output to be connected or disconnected from the load or heating element 108, while the MOSFET 306 allows the DC source or battery 114 to be connected or disconnected. Thus, both of these sources may be selected individually to operate alone or in parallel on the heating element 108.

The controller 116 is shown configured to selectively activate or connect the power sources 112, 114 to the heating element 108 via the solid-state switches 304, 306. This may be done, in part, based on readings from the temperature probes 105, 109 or other measurements or inputs. Control and instructions may also be provided by user controlled switchgear, thermostats, or other connected control devices.

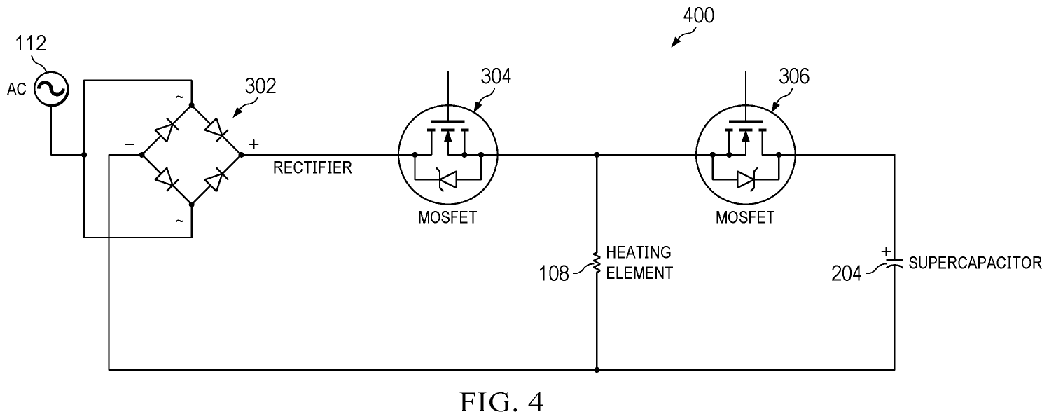

Referring now to FIG. 4 a circuit diagram 400 of a heating element 108 boosted by a supercapacitor 204 according to aspects of the present disclosure is shown. Operating in a similar fashion as the circuit of FIG. 3, the circuit of diagram 400 allows either the rectified AC source 112, the supercapacitor 204, or both, to be applied to the load or heating element 108. Here again, control or switching may be provided by the controller 116. It will be understood that the supercapacitor may be charged by various mechanisms and circuits known to the art. It may be charged by the AC source 112, for example, and then used at a later time along with the same AC source 112. A dedicated charging circuit (not shown) drawing power from the AC source 112 may also be used.

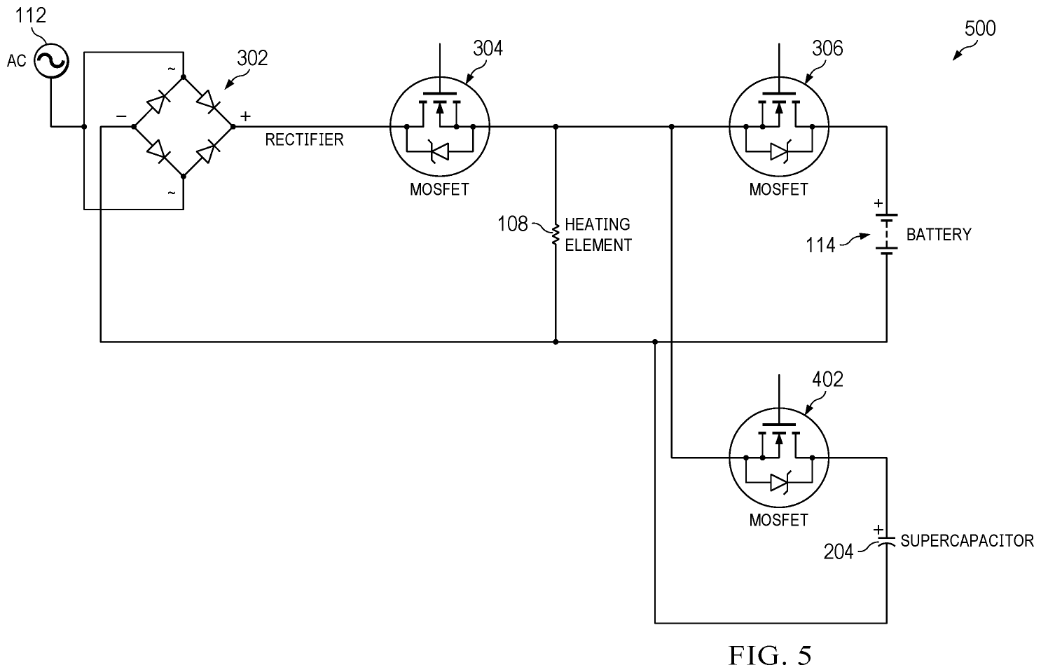

Referring now to FIG. 5, a circuit diagram 500 of a heating element 108 boosted by two different DC power sources according to aspects of the present disclosure is shown. Here the battery 114 and the capacitor 204 are available to boost power to the heating element 108 via MOSFETs 306, 402, respectively. Other switching devices may be used and these may be configured such that all or only a part of the current or voltage available from the battery 114 and/or capacitor 204 is provided to the heating element on demand, instead of, or in addition to, that from the AC source 112 via the rectifier 302 and MOSFET or other switching device 304.

It should be understood that where a separate booster heating element is used (e.g., 202, FIG. 2) the controller 116 and associated switches (e.g., 304, 306) may be configured such that power is selectively applied to the booster heating element by the AC source 112 or one or more of the DC sources 114, 204.

A system according to the present disclosure allows for distribution management of power from multiple sources (e.g., AC source 112, battery 114, capacitor 204) providing a variable input power rate into the cooking system. Power management according to the present disclosure allows for the consumer to energize different resistive heating elements (e.g., 108, 202) heating the cooking surface 104. It may also manage heat delivery to different cooking surfaces (similar to a multi-burner gas grill), which allows for zonal cooking (e.g., high temperature grilling on one module and medium temperature baking on the other one). The power management or controller 116 may also use the data collected and provided by temperature sensor(s) (e.g., 105, 109) to adjust a level of energy utilized in each heating element to minimize the warmup and recovery times in transient heat transfer conditions and to maximize available cook time during the steady-state conditions.

A variable power rate also allows for fine-tuned customized cooking that currently requires highly skilled cooks. Smart control according to the present disclosure (e.g., as implemented by controller 116) not only takes the values of measured temperatures in real time, but also the history of the temperature changes through time to optimize the power delivery to the designated heating element(s). An example of such is a situation when an electric grill (e.g., 100) is initially turned on in an extremely cold ambient. As the system measures and recognizes the extreme cold ambient, the energy stored in the DC source 114/204 is deployed with a high discharge rate as a booster to compensate for the cold ambient conditions. This results in an accelerated rate of the temperature rise in the cooking chamber 102. As the temperature increases, the rate of the power supply is adjusted to optimize the warmup time and the energy available for cooking.

Another example would be a situation when the system 100 detects a notable drop in the temperature (food, cooking grate, or cooking chamber) via one or more of the temperature probes 105/109. The drop could be in the temperature of the cooking grates (as several large pieces of raw meats are being placed on the grates), or of the air inside the cooking chamber (as the lid is opened). A controller 116 may utilize the data to again optimize the energy provided to the heating element(s) that can appropriately compensate for the energy loss and optimize the rate of heat transfer into the food being prepared on the grate 104.

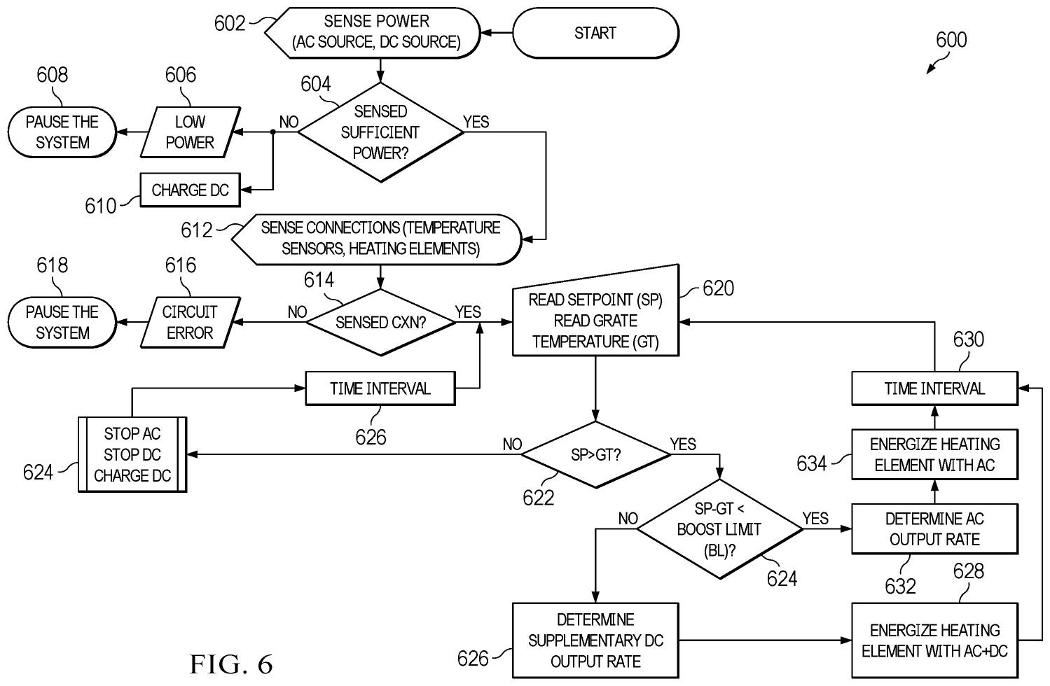

Referring now to FIG. 6, a flow chart 600 illustrating a control method for optimization of power sources according to aspects of the present disclosure is shown. FIG. 6 illustrates a control system using single temperature probe to manage the AC and DC sources based on the values of the setpoint, grill temperature, and their difference versus a predetermined parameter that identifies the need for boosting the power rate or the opportunity for saving on energy and/or recharging the DC source. Data collection and logical and switching operations may occur via the controller 116 or similar device or circuit.

At 602 power is sensed including the AC and DC source. At 604 if insufficient power is available for the requested operation a low power signal is indicated at 606, which may pause system at step 608, while the DC source is charged at step 610. The pause, and need for charging may be indicated to the user via control screen or other device.

If sufficient power is available, sensing of connections may occur at step 612. These may include sensing connection of temperature sensors, heating elements, or other devices. If any connections are absent or faulty at step 614, an error may be indicated to the user at 616, and the system paused at step 618.

With properly sensed connections, setpoints and grate temperature may be read at step 620. If the setpoint is not greater than the grate temperature at step 622, both AC and DC power may be halted at step 624 while DC power may be recharged. A time interval may be allowed to pass at step 626 before returning to step 620.

If the setpoint is higher than the grate temperature at step 620, it may be determined if the difference between the setpoint and grate temperature is less than a boost limit at step 624. If not, a supplementary DC output may be determined at step 626 before energizing with AC and DC at step 628. A time interval may be allowed to pass at step 630 before control returns to the reading of the setpoint and/or grate temperature at step 620.

If the difference is less than the boost limit, an AC rate alone may be determined at step 632, before energizing heating at step 632 before proceeding to the time interval at step 630 and back to the reading step 620.

One of skill in the art will appreciate that variations of the control method are possible while retaining some of all of the benefits of the methods and systems of the present disclosure.

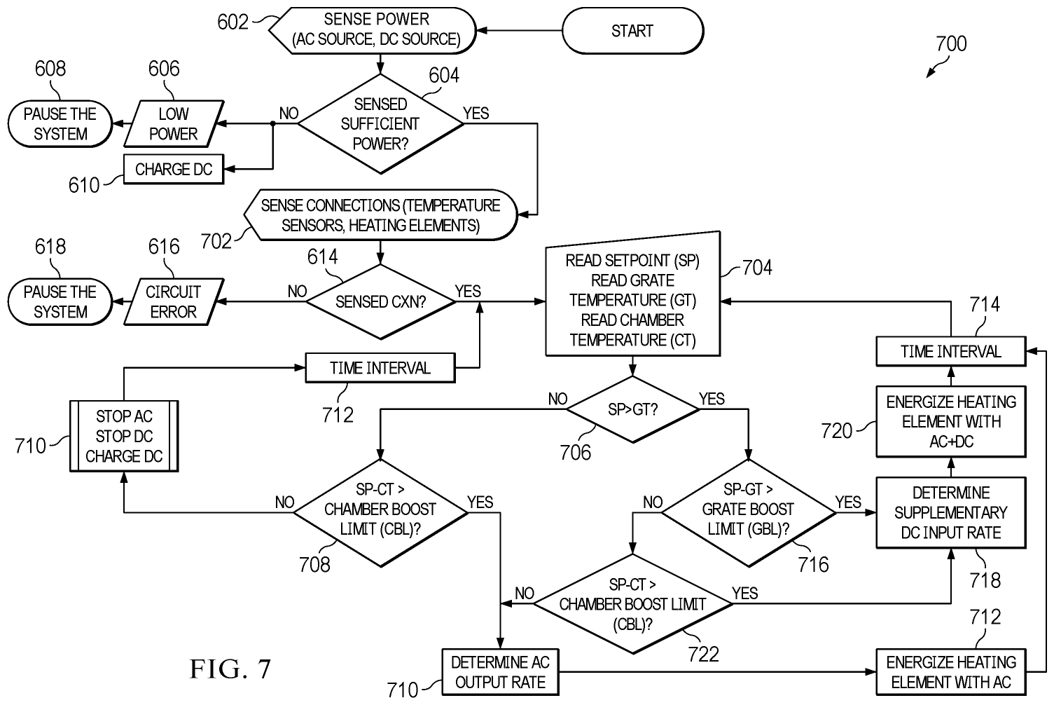

FIG. 7 shows an alternative control method for a system that uses a multi-probe configuration. Here a control method differentiates between grate and chamber temperature according to aspects of the present disclosure. The system uses the values of the setpoint, cooking grate temperature, cooking chamber temperature, and different predetermined boost thresholds for the grate and the chamber to optimize the level of energy discharge from the AC and DC sources into the grill. The illustrations show the scenario with one heating element. However, more than one heating element may be present with each energized independently of each other or in synergy with each other. As before, control and switching may be executed by controller 116 or a similar device or circuit.

Sensing and low power steps 604, 606, 608, 610 in the method 700 may be substantially similar to the corresponding steps of method 600. However, sensing step 604 may sense more connections as multiple temperature probes are used. Again, error steps at 614, 616, 618 may be substantially similar to those of method 600.

At step 704 temperature setpoint, grate temperature, and cooking chamber temperature are all read. At step 706 it is determined whether the setpoint is higher than the grate temperature. If not, at step 708 it may be determined whether a difference between the setpoint and the chamber temperature exceeds a chamber boost limit. If not, AC and DC energizing may be halted while DC may be charged at step 710. A time interval may be allowed to pass at step 712 before the reading step at 704 repeats. On the other hand, if the difference between the setpoint and chamber temperature exceeds the chamber boost limit at step 708, an AC output rate may be determined at step 710 following by energizing the heating element with AC only at step 712. Following this, a time interval may be allowed to pass at 714 before returning to the reading step at step 704.

Returning to step 706, if the setpoint is higher than the grate temperature, it may be determined whether a difference between the setpoint and the grate temperature exceeds a grate boost limit at step 716. If so, a supplementary DC input rate is determined at step 718 that is used for energizing with both AC and DC at step 720 before moving to time interval delay 714 and back to step 704. If the difference between the setpoint and grate temperature does not exceed the grate boost limit at step 716, but the difference between the chamber temperature and setpoint exceeds the chamber boost limit at step 722, the DC supplement rate is determined at step 718 in any event. If the difference between the chamber temperature and setpoint does not exceed the chamber boost limit at step 722, the AC rate is determined at step 710.

Here again, one of skill in the art will appreciate that variations of the control method are possible while retaining some or all of the benefits of the methods and systems of the present disclosure.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking grill comprising:
a cooking grate;
at least one resistive heating element below the cooking grate and radiating heat to the cooking grate when a voltage is applied thereto;
a first power source providing an alternating current; and
a second power source providing direct current;
wherein the first and second power sources provide voltage to the at least one resistive heating element individually or simultaneously.

2. The cooking grill of claim 1, wherein the first power source connects to the at least one resistive heating element via a rectifier.

3. The cooking grill of claim 2, wherein the first power source comprises a connection to a household alternating current.

4. The cooking grill of claim 3, wherein the second power source comprises a battery.

5. The cooking grill of claim 3, wherein the second power source comprises a capacitor.

6. The cooking grill of claim 3, wherein the first and second power sources provide power to the at least one resistive heating element simultaneously in series with one another.

7. The cooking grill of claim 3, wherein the first and second power sources provide power to the at least one resistive heating element simultaneously in parallel with one another.

8. The cooking grill of claim 3, wherein the first power source connects to the at least one resistive heating element via a solid-state switch.

9. The cooking grill of claim 3, wherein the second power supply connects to the at least one resistive heating element via a solid-state switch.

10. The cooking grill of claim 3, wherein the at least one resistive heating element comprises a first resistive heating element provided voltage by the first power source and a second resistive heating element provided voltage by the second power source.

11. A cooking grill comprising:
a cooking chamber having a cooking surface;
a resistive heating element below the cooking surface;
a connection to a household voltage source selectively powering the resistive heating element; and
a rechargeable voltage source selectively powering the resistive heating element;
wherein the household voltage source and the rechargeable voltage source may be selected individually or simultaneously to energize the resistive heating element resulting in radiative heat being applied to the cooking surface.

12. The cooking grill of claim 11, further comprising a first solid-state switch interposing the connection to the household voltage source and the resistive heating element, and a second solid-state switch interposing the rechargeable voltage source and the resistive heating element.

13. The cooking grill of claim 12, wherein the rechargeable voltage source comprises a battery.

14. The cooking grill of claim 12, wherein the rechargeable voltage source comprises a capacitor.

15. The cooking grill of claim 12, wherein the connection to the household voltage source recharges the rechargeable voltage source.

16. The cooking grill of claim 12, further comprising a second rechargeable voltage source selectively powering the resistive heating element in parallel with the first rechargeable voltage source.

17. The cooking grill of claim 11, further comprising at least one temperature probe connected to a controller that selects both the household voltage source and the rechargeable voltage source to power the resistive heating element when the at least one temperature probe detects a temperature below a predetermined threshold.

18. A cooking grill comprising:
a cooking chamber having a cooking surface;
at least one resistive heating element situated such that radiative heat from the resistive eating element heats the cooking surface;
a first power connection to a household alternating current;
a second power connection to a rechargeable current source;
a first solid-state switch connecting the first power connection to the at least one resistive heating element;
a second solid-state switch connecting the second power connection to the at least one resistive heating element;
at least one temperature probe; and
a controller that selectively activates the first solid-state switch and the second solid-state switch to power the at least one resistive heating element with either or both of the first power connection and second power connection based on data from the at least one temperature probe.

19. The cooking grill of claim 18, wherein the rechargeable current source comprises a battery that is recharged by the first power connection when the first power connection is not powering the at least one resistive heating element.

20. The cooking grill of claim 18, wherein the at least one resistive heating element comprises a first heating element connected to the first power connection via the first solid-state switch and a second heating element connected to the second power connection via the second solid-state switch.
